(19) United States
(12) Patent Application Publication
(10) Pub. No.: US 2022/0205789 A1
(43) Pub. Date: Jun. 30, 2022

(54) VEHICLE CONTROL SYSTEM AND OWN VEHICLE POSITION ESTIMATING METHOD

(71) Applicant: HONDA MOTOR CO., LTD., Tokyo (JP)

(72) Inventor: Koichiro WADA, Saitama (JP)

(21) Appl. No.: 17/559,217

(22) Filed: Dec. 22, 2021

(30) Foreign Application Priority Data
Dec. 28, 2020 (JP) 2020-219179

(51) Int. Cl. G01C 21/16; G01C 21/32; G01C 21/00; G01C 21/36

(52) U.S. Cl. CPC G01C 21/1656; G01C 21/32; G01C 21/3647; G01C 21/3602; G01C 21/3833

(57) ABSTRACT

A vehicle control system includes a movement amount calculating unit configured to calculate a movement amount of a vehicle by using dead reckoning, an imaging device configured to capture an image of a travel route on which the vehicle is traveling, a map generating unit configured to generate a map of a surrounding area of the vehicle, and an own vehicle position estimating unit configured to estimate a position of the vehicle on the map. The own vehicle position estimating unit is configured to calculate a first own vehicle position based on the movement amount of the vehicle calculated by the movement amount calculating unit, calculate a second own vehicle position by comparing the image captured by the imaging device with the map, and estimate the position of the vehicle on the map based on the first own vehicle position and the second own vehicle position.

### TECHNICAL FIELD

The present invention relates to a vehicle control system and an own vehicle position estimating method.

### BACKGROUND ART

Conventionally, various methods have been proposed for estimating a position of a vehicle on a map by using the so-called dead reckoning. For example, a navigation device disclosed in JP2007-263662A includes a dead reckoning means for calculating coordinates of an own vehicle position by using dead reckoning, and a map matching means for performing map matching of the coordinates of the own vehicle position acquired by the dead reckoning means on a road map data.

The position of the vehicle estimated by using dead reckoning is unlikely to show a large momentary deviation from an actual position of the vehicle, but likely to show a long-term deviation from the actual position of the vehicle. Accordingly, if the position of the vehicle on the map is estimated based only on dead reckoning, the position of the vehicle on the map may not be estimated accurately.

### SUMMARY OF THE INVENTION

In view of the above background, an object of the present invention is to provide a vehicle control system and an own vehicle position estimating method that can accurately estimate a position of a vehicle on a map.

To achieve such an object, one aspect of the present invention provides a vehicle control system (1), comprising: a movement amount calculating unit (32) configured to calculate a movement amount of a vehicle (V) by using dead reckoning; an imaging device (18) configured to capture an image of a travel route on which the vehicle is traveling; a map generating unit (53) configured to generate a map of a surrounding area of the vehicle; and an own vehicle position estimating unit (54) configured to estimate a position of the vehicle on the map, wherein the own vehicle position estimating unit is configured to calculate a first own vehicle position based on the movement amount of the vehicle calculated by the movement amount calculating unit, calculate a second own vehicle position by comparing the image captured by the imaging device with the map, and estimate the position of the vehicle on the map based on the first own vehicle position and the second own vehicle position.

The above first own vehicle position, which is calculated based on dead reckoning, is unlikely to show a large momentary deviation from an actual position of the vehicle. Further, the above second own vehicle position, which is calculated based on the image captured by the imaging device, is unlikely to show a long-term deviation from the actual position of the vehicle. Accordingly, by estimating the position of the vehicle on the map based on the first own vehicle position and the second own vehicle position as described above, it is possible to suppress both a large momentary deviation and a long-term deviation from the actual position of the vehicle, and thus accurately estimate the position of the vehicle on the map.

In the above aspect, preferably, the own vehicle position estimating unit includes: a high-pass filter (63) configured to execute a filtering process to a first own vehicle signal corresponding to the first own vehicle position; a low-pass filter (64) configured to execute a filtering process to a second own vehicle signal corresponding to the second own vehicle position; and an adder (62) configured to add the first own vehicle signal that has passed through the high-pass filter and the second own vehicle signal that has passed through the low-pass filter so as to generate a map own vehicle signal corresponding to the position of the vehicle on the map, and a common time constant is set for the high-pass filter and the low-pass filter.

According to this aspect, by changing the time constant, it is possible to freely adjust the weighting of the first own vehicle position and the second own vehicle position in the position of the vehicle on the map.

In the above aspect, preferably, the own vehicle position estimating unit is configured to calculate first reliability that is reliability of a delimiting line recognized from the image captured by the imaging device, calculate second reliability that is reliability of a delimiting line on the map, set the time constant greater in a case where the first reliability is less than a first reference value as compared with a case where the first reliability is equal to or more than the first reference value, and set the time constant smaller in a case where the second reliability is less than a second reference value as compared with a case where the second reliability is equal to or more than the second reference value.

According to this aspect, it is possible to set the time constant to an appropriate value based on the reliability of the delimiting line recognized from the image captured by the imaging device and the reliability of the delimiting line on the map. Accordingly, it is possible to more accurately estimate the position of the vehicle on the map.

In the above aspect, preferably, the own vehicle position estimating unit is configured to set the time constant greater in a case where the vehicle is stopped as compared with a case where the vehicle is traveling.

According to this aspect, it is possible to set the time constant to an appropriate value based on a travel state of the vehicle. Accordingly, it is possible to more accurately estimate the position of the vehicle on the map.

In the above aspect, preferably, the own vehicle position estimating unit is configured to execute a correcting process for correcting the position of the vehicle on the map, and set the time constant smaller in a case where the own vehicle position estimating unit corrects the position of the vehicle in a travel direction thereof in the correcting process as compared with a case where the own vehicle position estimating unit does not correct the position of the vehicle in the travel direction thereof in the correcting process.

According to this aspect, it is possible to set the time constant to an appropriate value based on whether the position of the vehicle in the travel direction is corrected. Accordingly, it is possible to more accurately estimate the position of the vehicle on the map.

In the above aspect, preferably, the own vehicle position estimating unit is configured to decrease the time constant as a radius of curvature of the travel route becomes smaller.

According to this aspect, it is possible to set the time constant to an appropriate value according to the degree of curvature of the travel route. Accordingly, it is possible to more accurately estimate the position of the vehicle on the map.

In the above aspect, preferably, the own vehicle position estimating unit is configured to stop estimating the position of the vehicle on the map in a case where both the first own vehicle position and the second own vehicle position cannot be calculated, and estimate the position of the vehicle on the map based on only one of the first own vehicle position and the second own vehicle position in a case where the only one of the first own vehicle position and the second own vehicle position can be calculated.

According to this aspect, even when the other one of the first own vehicle position and the second own vehicle position cannot be calculated, the position of the vehicle on the map can be estimated. Accordingly, it is possible to increase the probability that the position of the vehicle on the map can be estimated.

To achieve the above object, another aspect of the present invention provides an own vehicle position estimating method for estimating a position of a vehicle (V) on a map, the own vehicle position estimating method comprising: calculating a first own vehicle position based on a movement amount of the vehicle calculated by using dead reckoning; calculating a second own vehicle position by comparing a captured image with the map; and estimating the position of the vehicle on the map based on the first own vehicle position and the second own vehicle position.

The above first own vehicle position, which is calculated based on dead reckoning, is unlikely to show a large momentary deviation from an actual position of the vehicle. Further, the above second own vehicle position, which is calculated based on the captured image, is unlikely to show a long-term deviation from the actual position of the vehicle. Accordingly, by estimating the position of the vehicle on the map based on the first own vehicle position and the second own vehicle position as described above, it is possible to suppress both a large momentary deviation and a long-term deviation from the actual position of the vehicle, and thus accurately estimate the position of the vehicle on the map.

Thus, according to the above aspects, it is possible to provide a vehicle control system and an own vehicle position estimating method that can accurately estimate a position of a vehicle on a map.

### BRIEF DESCRIPTION OF THE DRAWING(S)

FIG. 1 is a block diagram of a vehicle control system according to an embodiment of the present invention;

FIG. 2 is a flowchart showing own vehicle position estimating control according to the embodiment of the present invention;

FIG. 3 is a block diagram of a position identifying unit according to the embodiment of the present invention; and

FIG. 4 is a plan view showing an example of changes in a first own vehicle position, a second own vehicle position, and an LM own vehicle position on a local map.

### DETAILED DESCRIPTION OF THE INVENTION

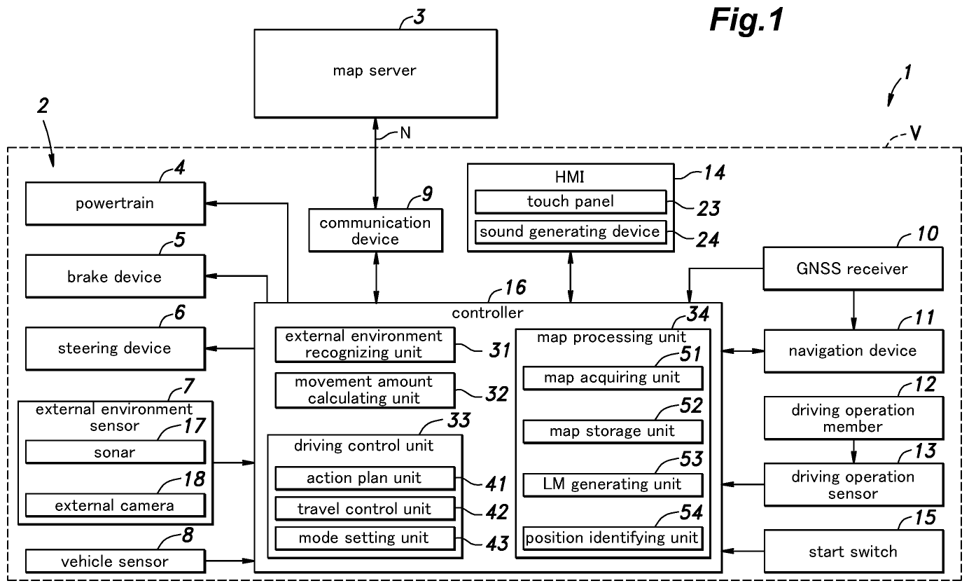

In the following, a vehicle control system 1 according to an embodiment of the present invention will be described with reference to the drawings. As shown in FIG. 1, the vehicle control system 1 includes a vehicle system 2 mounted on a vehicle V, and a high-precision map server 3 (hereinafter, abbreviated as “the map server 3”) connected to the vehicle system 2 via a network N. Hereinafter, the word “the vehicle V” indicates a vehicle (namely, the own vehicle) provided with the vehicle system 2.

### <The Vehicle System 2>

First, the vehicle system 2 will be described. The vehicle system 2 includes a powertrain 4, a brake device 5, a steering device 6, an external environment sensor 7, a vehicle sensor 8, a communication device 9, a GNSS receiver 10, a navigation device 11, a driving operation member 12, a driving operation sensor 13, an HMI 14, a start switch 15, and a controller 16. Each component of the vehicle system 2 is connected to each other via a communication means such as Controller Area Network (CAN) such that signals can be transmitted therebetween.

The powertrain 4 is a device configured to apply a driving force to the vehicle V. For example, the powertrain 4 includes at least one of an internal combustion engine (such as a gasoline engine and a diesel engine) and an electric motor. The brake device 5 is a device configured to apply a brake force to the vehicle V. For example, the brake device 5 includes a brake caliper configured to press a pad against a brake rotor and an electric cylinder configured to supply an oil pressure to the brake caliper. The brake device 5 may further include a parking brake device configured to restrict rotation of wheels via wire cables. The steering device 6 is a device configured to change the steering angles of the wheels. For example, the steering device 6 includes a rack-and-pinion mechanism configured to steer the wheels and an electric motor configured to drive the rack-and-pinion mechanism. The powertrain 4, the brake device 5, and the steering device 6 are controlled by the controller 16.

The external environment sensor 7 is a sensor configured to detect an object outside the vehicle V or the like by capturing electromagnetic waves, sound waves, or the like from the surroundings of the vehicle V. The external environment sensor 7 includes a plurality of sonars 17 and a plurality of external cameras 18 (an example of an imaging device). The external environment sensor 7 may further include a millimeter wave radar and/or a laser lidar. The external environment sensor 7 is configured to output a detection result to the controller 16.

Each sonar 17 consists of a so-called ultrasonic sensor. The sonar 17 emits ultrasonic waves to the surroundings of the vehicle V and captures the reflected waves therefrom, thereby detecting a position (distance and direction) of the object. The plurality of sonars 17 are provided at a rear part and a front part of the vehicle V, respectively.

Each external camera 18 is a device configured to capture an image of the surroundings of the vehicle V. For example, the external camera 18 is a digital camera that uses a solid imaging element such as a CCD and a CMOS. The external camera 18 may consist of a stereo camera or a monocular camera. The plurality of external cameras 18 include a front camera configured to capture an image in front of the vehicle V, a rear camera configured to capture an image behind the vehicle V, and a pair of side cameras configured to capture images on both lateral sides of the vehicle V. When the vehicle V is traveling, each external camera 18 captures an image of a travel route on which the vehicle V is traveling at prescribed intervals (for example, at prescribed spatial intervals or prescribed temporal intervals).

The vehicle sensor 8 is a sensor configured to detect the state of the vehicle V. The vehicle sensor 8 includes a vehicle speed sensor configured to detect the speed of the vehicle V, an acceleration sensor configured to detect the acceleration of the vehicle V, a yaw rate sensor configured to detect the angular velocity around a vertical axis of the vehicle V, a direction sensor configured to detect the direction of the vehicle V, and the like. For example, the yaw rate sensor consists of a gyro sensor. The vehicle sensor 8 may further include an inclination sensor configured to detect the inclination of a vehicle body and a wheel speed sensor configured to detect the rotational speed of each wheel.

The communication device 9 is configured to mediate communication between the controller 16 and a device (for example, the map server 3) outside the vehicle V. The communication device 9 includes a router configured to connect the controller 16 to the Internet. The communication device 9 may have a wireless communication function of mediating wireless communication between the controller 16 of the vehicle V and the controller of the surrounding vehicle and between the controller 16 of the vehicle V and a roadside device on a road.

The GNSS receiver 10 is configured to receive a signal (hereinafter referred to as “the GNSS signal”) relating to the position (latitude and longitude) of the vehicle V from each of satellites that constitute a Global Navigation Satellite System (GNSS). The GNSS receiver 10 is configured to output the received GNSS signal to the navigation device 11 and the controller 16.

The navigation device 11 consists of a computer provided with known hardware. The navigation device 11 is configured to identify the position (latitude and longitude) of the vehicle V based on the previous traveling history of the vehicle V and the GNSS signal output from the GNSS receiver 10. The navigation device 11 is configured to store data (hereinafter referred to as “the navigation map data”) on roads of a region or a country on which the vehicle V is traveling. The navigation device 11 is configured to store the navigation map data in a RAM, an HDD, an SSD, or the like.

The navigation device 11 is configured to set, based on the GNSS signal and the navigation map data, a route from a current position of the vehicle V to a destination input by an occupant, and output the route to the controller 16. When the vehicle V starts traveling, the navigation device 11 provides the occupant with route guidance to the destination.

The driving operation member 12 is provided in a vehicle cabin and configured to accept an input operation the occupant performs to control the vehicle V. The driving operation member 12 includes a steering wheel, an accelerator pedal, and a brake pedal. The driving operation member 12 may further include a shift lever, a parking brake lever, a blinker lever, and the like.

The driving operation sensor 13 is a sensor configured to detect an operation amount of the driving operation member 12. The driving operation sensor 13 includes a steering angle sensor configured to detect an operation amount of the steering wheel, an accelerator sensor configured to detect an operation amount of the accelerator pedal, and a brake sensor configured to detect an operation amount of the brake pedal. The driving operation sensor 13 is configured to output the detected operation amount to the controller 16. The driving operation sensor 13 may further include a grip sensor configured to detect that the occupant grips the steering wheel. For example, the grip sensor consists of at least one capacitive sensor provided on an outer circumferential portion of the steering wheel.

The HMI 14 is configured to notify the occupant of various kinds of information by display and/or voice, and accept an input operation by the occupant. For example, the HMI 14 includes a touch panel 23 and a sound generating device 24. The touch panel 23 includes a liquid crystal display, an organic EL display, or the like, and is configured to accept the input operation by the occupant. The sound generating device 24 consists of a buzzer and/or a speaker. The HMI 14 is configured to display a driving mode switch button on the touch panel 23. The driving mode switch button is a button configured to accept a switching operation of a driving mode (for example, an autonomous driving mode and a manual driving mode) of the vehicle V by the occupant.

The HMI 14 also functions as an interface to mediate the input to/the output from the navigation device 11. Namely, when the HMI 14 accepts the input operation of the destination by the occupant, the navigation device 11 starts a route setting to the destination. Further, when the navigation device 11 provides the route guidance to the destination, the HMI 14 displays the current position of the vehicle V and the route to the destination.

The start switch 15 is a switch for starting the vehicle system 2. Namely, the occupant presses the start switch 15 while sitting on the driver's seat and pressing the brake pedal, and thus the vehicle system 2 is started.

The controller 16 consists of at least one electronic control unit (ECU) including a CPU, a ROM, a RAM, and the like. The CPU executes operation processing according to a program, and thus the controller 16 executes various types of vehicle control. The controller 16 may consist of one piece of hardware, or may consist of a unit including plural pieces of hardware. The functions of the controller 16 may be at least partially executed by hardware such as an LSI, an ASIC, and an FPGA, or may be executed by a combination of software and hardware.

The controller 16 includes an external environment recognizing unit 31 (an example of a delimiting line estimating unit), a movement amount calculating unit 32, a driving control unit 33, and a map processing unit 34. These components may be composed of separate electronic control units or integrated electronic control units.

The external environment recognizing unit 31 is configured to recognize an object that is present in the surroundings of the vehicle V based on the detection result of the external environment sensor 7, and thus acquire information on the position and size of the object. The object recognized by the external environment recognizing unit 31 includes delimiting lines, lanes, road ends, road shoulders, and obstacles, which are present on the travel route of the vehicle V. Each delimiting line is a line shown along a vehicle travel direction. Each lane is an area delimited by one or more delimiting lines. Each road end is an end of the travel route of the vehicle V. Each road shoulder is an area between the delimiting line arranged at an end in the vehicle width direction (lateral direction) and the road end. Each obstacle may be a barrier (guardrail), a utility pole, a surrounding vehicle, a pedestrian, or the like.

The external environment recognizing unit 31 is configured to recognize, based on the image (hereinafter referred to as “the camera image”) captured by each external camera 18, the position of the delimiting line (hereinafter referred to as “the camera delimiting line”) in the camera image. For example, the external environment recognizing unit 31 is configured to extract points (hereinafter referred to as “the candidate points”) whose density value changes by a threshold or more in the camera image, and recognize a straight line passing through the candidate points as the camera delimiting line. The external environment recognizing unit 31 is configured to identify the type of the camera delimiting line based on the camera image. The type of the camera delimiting line includes a single solid line, a single broken line, a deceleration promotion line, and a double solid line. The deceleration promotion line consists of, for example, a broken line with shorter intervals and a greater width than the single broken line.

The movement amount calculating unit 32 is configured to calculate, based on the signal from the vehicle sensor 8, a movement amount of the vehicle V (a movement distance and a movement direction of the vehicle V) by using dead reckoning such as odometry and inertial navigation. For example, the movement amount calculating unit 32 is configured to calculate the movement amount of the vehicle V based on the rotational speed of each wheel detected by the wheel speed sensor, the acceleration of the vehicle V detected by the acceleration sensor, and the angular velocity of the vehicle V detected by the gyro sensor. Hereinafter, the movement amount of the vehicle V the movement amount calculating unit 32 calculates by using dead reckoning will be referred to as “the DR movement amount of the vehicle V”.

The driving control unit 33 includes an action plan unit 41, a travel control unit 42, and a mode setting unit 43.

The action plan unit 41 is configured to create an action plan for causing the vehicle V to travel along the route set by the navigation device 11. The action plan unit 41 is configured to output a travel control signal corresponding to the created action plan to the travel control unit 42.

The travel control unit 42 is configured to control the powertrain 4, the brake device 5, and the steering device 6 based on the travel control signal from the action plan unit 41. Namely, the travel control unit 42 is configured to cause the vehicle V to travel according to the action plan created by the action plan unit 41.

The mode setting unit 43 is configured to switch the driving mode of the vehicle V between the manual driving mode and the autonomous driving mode. In the manual driving mode, the travel control unit 42 controls the powertrain 4, the brake device 5, and the steering device 6 according to the input operation on the driving operation member 12 by the occupant, thereby causing the vehicle V to travel. On the other hand, in the autonomous driving mode, the travel control unit 42 controls the powertrain 4, the brake device 5, and the steering device 6 regardless of the input operation on the driving operation member 12 by the occupant, thereby causing the vehicle V to travel autonomously.

The map processing unit 34 includes a map acquiring unit 51, a map storage unit 52, a local map generating unit 53 (an example of a map generating unit: hereinafter referred to as “the LM generating unit 53”), and a position identifying unit 54 (an example of an own vehicle position estimating unit).

The map acquiring unit 51 is configured to access the map server 3 and acquire dynamic map data (which will be described in detail later) from the map server 3. For example, the map acquiring unit 51 is configured to acquire, from the map server 3, the dynamic map data of an area corresponding to the route set by the navigation device 11.

The map storage unit 52 consists of a storage unit such as an HDD and an SSD. The map storage unit 52 is configured to store various kinds of information for causing the vehicle V to travel autonomously in the autonomous driving mode. The map storage unit 52 is configured to store the dynamic map data acquired by the map acquiring unit 51 from the map server 3.

The LM generating unit 53 is configured to generate a detailed map (hereinafter referred to as “the local map”) of the surrounding area of the vehicle V based on the dynamic map data stored in the map storage unit 52. The LM generating unit 53 is configured to generate the local map by extracting the data relating to the surrounding area of the vehicle V from the dynamic map data. Accordingly, the local map may include any information included in the dynamic map data. For example, the local map includes information on the lanes (for example, the number of lanes and the lane number of each lane) on the travel route and information on each delimiting line (for example, the type of the delimiting line) on the travel route. Further, the local map may include information on the object (for example, the obstacle) recognized by the external environment recognizing unit 31 based on the camera image and information on the past DR movement amount of the vehicle V (namely, the movement trajectory of the vehicle V). When the vehicle V is traveling autonomously in the autonomous driving mode, the LM generating unit 53 may update the local map at any time according to the travel position of the vehicle V.

The position identifying unit 54 is configured to execute various kinds of localization processes on the local map. For example, the position identifying unit 54 is configured to estimate the position of the vehicle V on the local map based on the GNSS signal output from the GNSS receiver 10, the DR movement amount of the vehicle V, the camera image, and the like. Further, the position identifying unit 54 is configured to identify the position of an own lane (a lane in which the vehicle V is traveling) on the local map based on the GNSS signal output from the GNSS receiver 10, the camera image, and the like. When the vehicle V is traveling autonomously in the autonomous driving mode, the position identifying unit 54 may update the position of the vehicle V and the position of the own lane on the local map at any time according to the travel position of the vehicle V.

### <The Map Server 3>

Next, the map server 3 will be described. As shown in FIG. 1, the map server 3 is connected to the controller 16 via the network N (in the present embodiment, the Internet) and the communication device 9. The map server 3 is a computer including a CPU, a ROM, a RAM, and a storage unit such as an HDD and an SSD. The dynamic map data is stored in the storage unit of the map server 3.

The dynamic map data includes static information, semi-static information, semi-dynamic information, and dynamic information. The static information includes 3D map data that is more precise than the navigation map data. The semi-static information includes traffic regulation information, road construction information, and wide area weather information. The semi-dynamic information includes accident information, traffic congestion information, and small area weather information. The dynamic information includes signal information, surrounding vehicle information, and pedestrian information.

The static information of the dynamic map data includes information on lanes (for example, the number of lanes and the lane number of each lane) on the travel route and information on each delimiting line on the travel route (for example, the type of the delimiting line). For example, the delimiting line in the static information is represented by nodes arranged at prescribed intervals and links connecting the nodes.

### <The Own Vehicle Position Estimating Control>

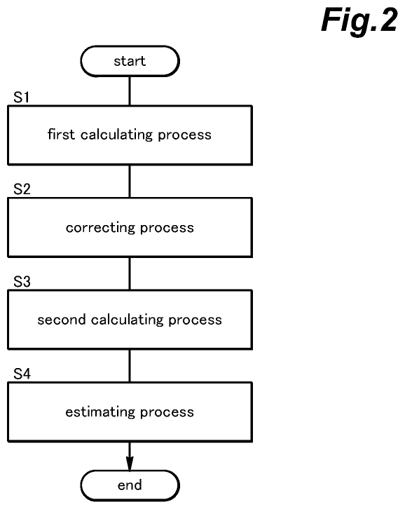

Next, with reference to FIG. 2, an outline of own vehicle position estimating control (an example of an own vehicle position estimating method) for estimating the position of the vehicle V on the local map will be described. Hereinafter, the position in the vehicle travel direction (the front-and-rear direction) will be referred to as “the lengthwise position”, and the position in the vehicle width direction (the lateral direction) will be referred to as “the widthwise position”. Further, the position of the vehicle V on the local map will be referred to as “the LM own vehicle position”, and the delimiting line on the local map will be referred to as “the LM delimiting line”.

When the own vehicle position estimating control is started, the position identifying unit 54 executes a first calculating process (step S1). In the first calculating process, the position identifying unit 54 calculates a first own vehicle position based on the DR movement amount of the vehicle V.

Next, the position identifying unit 54 executes a correcting process (step S2). In the correcting process, the position identifying unit 54 corrects the lengthwise position and/or the widthwise position of a base own vehicle position (a position of the vehicle V calculated based on the DR movement amount of the vehicle V when the GNSS receiver 10 cannot receive the GNSS signal), if necessary.

Next, the position identifying unit 54 executes a second calculating process (step S3). In the second calculating process, the position identifying unit 54 calculates a second own vehicle position by comparing the camera image with the local map.

Next, the position identifying unit 54 executes an estimating process (step S4). In the estimating process, the position identifying unit 54 estimates the LM own vehicle position based on the first own vehicle position and/or the second own vehicle position.

### <The First Calculating Process>

Next, the first calculating process (step S1) in the own vehicle position estimating control will be described.

In the first calculating process, the position identifying unit 54 determines whether the LM own vehicle position has been estimated in the last (previous) own vehicle position estimating control. In a case where the LM own vehicle position has been estimated in the last own vehicle position estimating control, the position identifying unit 54 calculates the first own vehicle position by adding the LM own vehicle position estimated in the last own vehicle position estimating control and the DR movement amount of the vehicle V, and sets 1 as a first calculation flag. On the other hand, in a case where the LM own vehicle position has not been estimated in the last own vehicle position estimating control, the position identifying unit 54 sets 0 as the first calculation flag without calculating the first own vehicle position.

### <The Correcting Process>

Next, the correcting process (step S2) in the own vehicle position estimating control will be described.

When the correcting process is started, the position identifying unit 54 calculates a correction amount (hereinafter referred to as “the lengthwise correction amount of the base own vehicle position”) of the lengthwise position of the base own vehicle position. For example, the position identifying unit 54 calculates the lengthwise correction amount of the base own vehicle position by selectively using the following calculating methods 1 to 3.

### <Calculating Method 1>

calculating method by using point sequence matching

### <Calculating Method 2>

a calculating method by using dead reckoning

### <Calculating Method 3>

a calculating method by using curvature matching

In the calculating method 1, the position identifying unit 54 calculates the lengthwise correction amount of the base own vehicle position by comparing the point sequence constituting the camera delimiting line with the point sequence constituting the LM delimiting line. For example, the position identifying unit 54 moves and rotates the base own vehicle position to a position and an angle to minimize the difference between the point sequence constituting the camera delimiting line and the point sequence constituting the LM delimiting line, and calculates the lengthwise correction amount of the base own vehicle position according to the movement amount and the rotation amount of the base own vehicle position at that time.

In the calculating method 2, the position identifying unit 54 calculates the lengthwise correction amount of the base own vehicle position based on the DR movement amount of the vehicle V in each detection cycle of the vehicle sensor 8 (for example, the wheel speed sensor).

In the calculating method 3, the position identifying unit 54 calculates the lengthwise correction amount of the base own vehicle position by comparing the curvature of the camera delimiting line with the curvature of the LM delimiting line. For example, the position identifying unit 54 moves and rotates the base own vehicle position to a position and an angle to minimize the difference between the curvature of the camera delimiting line and the curvature of the LM delimiting line, and calculates the lengthwise correction amount of the base own vehicle position according to the movement amount and the rotation amount of the base own vehicle position at that time.

For example, the position identifying unit 54 calculates the lengthwise correction amount of the base own vehicle position by the calculating method 1 in a case where the calculating method 1 is available. Further, the position identifying unit 54 calculates the lengthwise correction amount of the base own vehicle position by the calculating method 2 in a case where the calculating method 1 is unavailable. Further, the position identifying unit 54 calculates the lengthwise correction amount of the base own vehicle position by the calculating method 3 in a case where the calculating method 2 is unavailable. Namely, the position identifying unit 54 prioritizes the calculating methods 1 to 3 in the order of the calculating method 1, the calculating method 2, and the calculating method 3. In another embodiment, the position identifying unit 54 may prioritize the calculating methods 1 to 3 in an order different from that of the present embodiment.

The position identifying unit 54 corrects the lengthwise position of the base own vehicle position according to the lengthwise correction amount of the base own vehicle position calculated by any of the calculating methods 1 to 3. Incidentally, in a case where it is difficult to compare the camera delimiting line with the LM delimiting line (for example, in a case where the camera delimiting line and the LM delimiting line are linear because a linear travel route continues), the position identifying unit 54 may not correct the lengthwise position of the base own vehicle position. However, when ceasing to correct the lengthwise position of the base own vehicle position, the position identifying unit 54 may gradually decrease the lengthwise correction amount of the base own vehicle position, instead of immediately setting the lengthwise correction amount of the base own vehicle position to zero.

Incidentally, the position identifying unit 54 may correct the widthwise position of the base own vehicle position as necessary so as to improve the accuracy of the base own vehicle position after correcting the lengthwise position of the base own vehicle position. For example, the position identifying unit 54 may correct the widthwise position of the base own vehicle position based on the camera image or the like.

### <The Second Calculating Process>

Next, the second calculating process (step S3) in the own vehicle position estimating control will be described.

In the second calculating process, the position identifying unit 54 determines whether the camera image can be compared with the local map. For example, in a case where the external environment recognizing unit 31 can recognize the camera delimiting line and match the camera delimiting line with the LM delimiting line, the position identifying unit 54 determines that the camera image can be compared with the local map. On the other hand, in a case where the external environment recognizing unit 31 cannot recognize the camera delimiting line or match the camera delimiting line with the LM delimiting line, the position identifying unit 54 determines that the camera image cannot be compared with the local map.

In a case where the camera image can be compared with the local map, the position identifying unit 54 calculates the second own vehicle position by comparing the camera image with the local map (more specifically, the local map whose center matches the base own vehicle position after the correcting process), and sets 1 as a second calculation flag. For example, the position identifying unit 54 may compare the camera delimiting line with the LM delimiting line, and calculate the position of the vehicle V to match the camera delimiting line with the LM delimiting line as the second own vehicle position. On the other hand, in a case where the camera image cannot be compared with the local map, the position identifying unit 54 sets 0 as the second calculation flag without calculating the second own vehicle position.

### <The Estimating Process>

Next, the estimating process (step S4) in the own vehicle position estimating control will be described.

When the estimating process is started, the position identifying unit 54 confirms the first calculation flag and the second calculation flag. In a case where 0 is set as both the first calculation flag and the second calculation flag (namely, in a case where both the first own vehicle position and the second own vehicle position cannot be calculated), the position identifying unit 54 terminates the estimating process without estimating the LM own vehicle position.

On the other hand, in a case where 1 is set as the first calculation flag and 0 is set as the second calculation flag (namely, in a case where only the first own vehicle position can be calculated), the position identifying unit 54 estimates the LM own vehicle position based only on the first own vehicle position. For example, the position identifying unit 54 may estimate the first own vehicle position itself as the LM own vehicle position. In contrast, in a case where 0 is set as the first calculation flag and 1 is set as the second calculation flag (namely, in a case where only the second own vehicle position can be calculated), the position identifying unit 54 estimates the LM own vehicle position based only on the second own vehicle position. For example, the position identifying unit 54 may estimate the second own vehicle position itself as the LM own vehicle position.

On the other hand, in a case where 1 is set as both the first calculation flag and the second calculation flag (namely, in a case where both the first own vehicle position and the second own vehicle position can be calculated), the position identifying unit 54 estimates the LM own vehicle position based on the first own vehicle position and the second own vehicle position. In the following, the estimating method of the LM own vehicle position based on the first own vehicle position and the second own vehicle position will be described in detail.

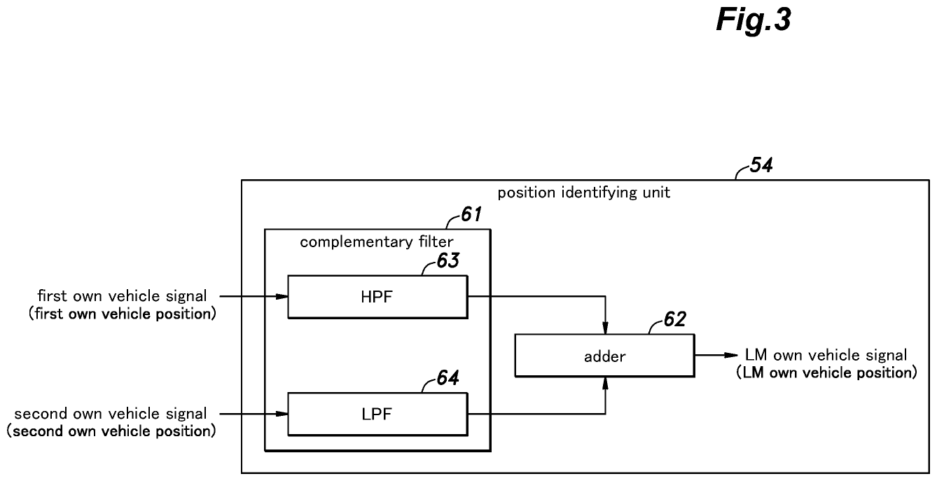

With reference to FIG. 3, the position identifying unit 54 includes a complementary filter 61 and an adder 62. The complementary filter 61 includes a high-pass filter 63 (hereinafter referred to as “the HPF 63”) and a low-pass filter 64 (hereinafter referred to as “the LPF 64”). A time constant (hereinafter referred to as “the common time constant”), which is common to the HPF 63 and the LPF 64, is set for the HPF 63 and the LPF 64.

The HPF 63 executes a filtering process to a signal (hereinafter referred to as “the first own vehicle signal”) corresponding to the first own vehicle position calculated in the first calculating process, thereby removing a low frequency component (namely, a frequency component lower than a cutoff frequency of the HPF 63) from the first own vehicle signal. The HPF 63 outputs the first own vehicle signal, from which the low frequency component has been removed, to the adder 62.

The LPF 64 executes a filtering process to a signal (hereinafter referred to as “the second own vehicle signal”) corresponding to the second own vehicle position calculated in the second calculating process, thereby removing a high frequency component (namely, a frequency component higher than a cutoff frequency of the LPF 64) from the second own vehicle signal. The LPF 64 outputs the second own vehicle signal, from which the high frequency component has been removed, to the adder 62.

The adder 62 adds the first own vehicle signal that has passed through the HPF 63 and the second own vehicle signal that has passed through the LPF 64 so as to generate an LM own vehicle signal (an example of a map own vehicle signal) corresponding to the LM own vehicle position. The position identifying unit 54 estimates the LM own vehicle position based on the LM own vehicle signal.

As the above common time constant decreases, the cutoff frequencies of the HPF 63 and the LPF 64 increase, and thus the first own vehicle signal passing through the HPF 63 decreases and the second own vehicle signal passing through the LPF 64 increases. Accordingly, the weighting of the first own vehicle signal in the LM own vehicle signal decreases, and the weighting of the second own vehicle signal in the LM own vehicle signal increases. Namely, the weighting of the first own vehicle position in the LM own vehicle position decreases, and the weighting of the second own vehicle position in the LM own vehicle position increases. On the other hand, as the common time constant increases, the weighting of the first own vehicle position in the LM own vehicle position increases and the weighting of the second own vehicle position in the LM own vehicle position decreases by the action opposite to the above action.

When estimating the LM own vehicle position based on the first own vehicle position and the second own vehicle position, the position identifying unit 54 calculates first reliability, which is reliability of the camera delimiting line. For example, the position identifying unit 54 may calculate the first reliability based on the number of candidate points through which the camera delimiting line passes. In this case, the position identifying unit 54 may increase the first reliability as the number of candidate points through which the camera delimiting line passes increases. Alternatively, the position identifying unit 54 may calculate the first reliability based on the length of a period in which the external environment recognizing unit 31 continuously recognizes the camera delimiting line. In this case, the position identifying unit 54 may increase the first reliability as the period in which the external environment recognizing unit 31 continuously recognizes the camera delimiting line is lengthened. The position identifying unit 54 sets the common time constant greater in a case where the first reliability is less than a prescribed first reference value as compared with a case where the first reliability is equal to or more than the first reference value.

When estimating the LM own vehicle position based on the first own vehicle position and the second own vehicle position, the position identifying unit 54 calculates second reliability that is reliability of the LM delimiting line. For example, the position identifying unit 54 calculates the second reliability based on a matching degree of the camera delimiting line and the LM delimiting line. In this case, the position identifying unit 54 may increase the second reliability as the matching degree of the camera delimiting line and the LM delimiting line increases. The position identifying unit 54 sets the common time constant smaller in a case where the second reliability is less than a prescribed second reference value as compared with a case where the second reliability is equal to or more than the second reference value.

In a case where the first reliability is equal to or more than the first reference value and the second reliability is equal to or more than the second reference value, the position identifying unit 54 calculates the common time constant based on the following rules 1 to 3.

### <Rule 1>

In a case where the vehicle V is stopped, the common time constant is set greater as compared with a case where the vehicle V is traveling.

### <Rule 2>

In a case where the lengthwise position of the base own vehicle position is corrected in the correcting process, the common time constant is set smaller as compared with a case where the lengthwise position of the base own vehicle position is not corrected in the correcting process.

### <Rule 3>

The common time constant is decreased as the radius of curvature of the travel route becomes smaller.

### <Effect>

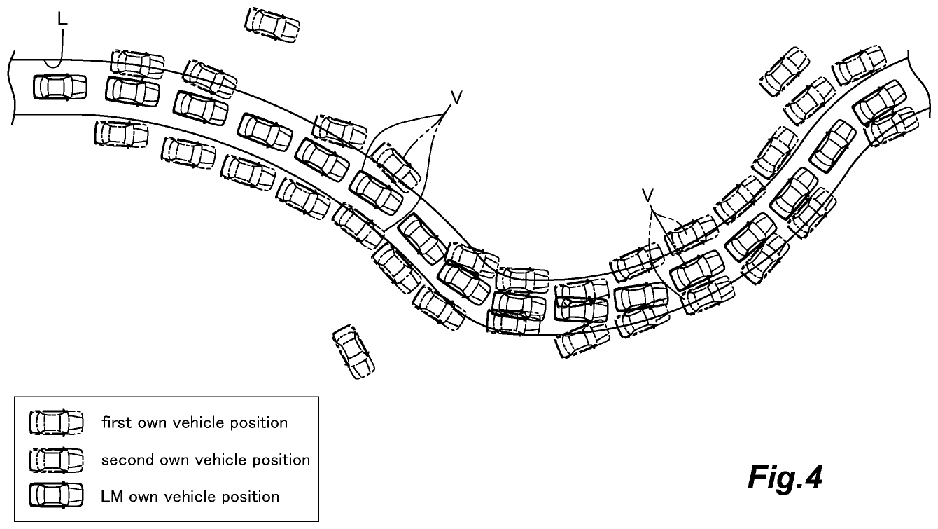

FIG. 4 shows an example of changes in the first own vehicle position, the second own vehicle position, and the LM own vehicle position on the local map. The first own vehicle position, which is calculated based on dead reckoning, is unlikely to show a large momentary deviation from an actual position (an actual position on the travel route L) of the vehicle V, but likely to show a long-term deviation from the actual position of the vehicle V. Namely, the first own vehicle position has high transitional properties but low stationary properties. In contrast, the second own vehicle position, which is calculated based on the camera image, is unlikely to show a long-term deviation from the actual position of the vehicle V but likely to show a large momentary deviation from an actual position of the vehicle V. Namely, the second own vehicle position has high stationary properties but low transitional properties.

Considering such likelihood, in the present embodiment, the position identifying unit 54 estimates the LM own vehicle position based on both the first own vehicle position and the second own vehicle position. Accordingly, it is possible to suppress both a large momentary deviation and a long-term deviation from the actual position of the vehicle V, and thus accurately estimate the LM own vehicle position.

Further, the common time constant is set for the HPF 63 and the LPF 64. Accordingly, by changing the common time constant, it is possible to freely adjust the weighting of the first own vehicle position and the second own vehicle position in the LM own vehicle position.

Further, the position identifying unit 54 sets the common time constant greater in a case where the first reliability (the reliability of the camera delimiting line) is less than a first reference value as compared with a case where the first reliability is equal to or more than the first reference value, and sets the common time constant smaller in a case where the second reliability (the reliability of the LM delimiting line) is less than the second reference value as compared with a case where the second reliability is equal to or more than the second reference value. Accordingly, it is possible to set the common time constant to an appropriate value based on the first reliability and the second reliability. Accordingly, it is possible to more accurately estimate the LM own vehicle position.

Further, the position identifying unit 54 sets the common time constant greater in a case where the vehicle V is stopped as compared with a case where the vehicle V is traveling. Accordingly, it is possible to set the common time constant to an appropriate value based on a travel state of the vehicle V. Accordingly, it is possible to more accurately estimate the LM own vehicle position.

Further, the position identifying unit 54 sets the common time constant smaller in a case where the position identifying unit 54 corrects the lengthwise position of the base own vehicle position in the correcting process as compared with a case where the position identifying unit 54 does not correct the lengthwise position of the base own vehicle position in the correcting process. Accordingly, it is possible to set the common time constant to an appropriate value based on whether the lengthwise position of the base own vehicle position is corrected. Accordingly, it is possible to more accurately estimate the LM own vehicle position.

Further, the position identifying unit 54 decreases the common time constant as the radius of curvature of the travel route becomes smaller. Accordingly, it is possible to set the common time constant to an appropriate value according to the degree of curvature of the travel route. Accordingly, it is possible to more accurately estimate the LM own vehicle position.

Further, the position identifying unit 54 estimates the LM own vehicle position based on only one of the first own vehicle position and the second own vehicle position in a case where the only one of the first own vehicle position and the second own vehicle position can be calculated. Accordingly, even when the other one of the first own vehicle position and the second own vehicle position cannot be calculated, the LM own vehicle position can be estimated. Accordingly, it is possible to increase the probability that the LM own vehicle position can be estimated.

Concrete embodiments of the present invention have been described in the foregoing, but the present invention should not be limited by the foregoing embodiments and various modifications and alterations are possible within the scope of the present invention.

1. A vehicle control system, comprising:
a movement amount calculating unit configured to calculate a movement amount of a vehicle by using dead reckoning;
an imaging device configured to capture an image of a travel route on which the vehicle is traveling;
a map generating unit configured to generate a map of a surrounding area of the vehicle; and
an own vehicle position estimating unit configured to estimate a position of the vehicle on the map,
wherein the own vehicle position estimating unit is configured to
calculate a first own vehicle position based on the movement amount of the vehicle calculated by the movement amount calculating unit,
calculate a second own vehicle position by comparing the image captured by the imaging device with the map, and
estimate the position of the vehicle on the map based on the first own vehicle position and the second own vehicle position.

2. The vehicle control system according to claim 1, wherein the own vehicle position estimating unit includes:
a high-pass filter configured to execute a filtering process to a first own vehicle signal corresponding to the first own vehicle position;
a low-pass filter configured to execute a filtering process to a second own vehicle signal corresponding to the second own vehicle position; and
an adder configured to add the first own vehicle signal that has passed through the high-pass filter and the second own vehicle signal that has passed through the low-pass filter so as to generate a map own vehicle signal corresponding to the position of the vehicle on the map, and
a common time constant is set for the high-pass filter and the low-pass filter.

3. The vehicle control system according to claim 2, wherein the own vehicle position estimating unit is configured to
calculate first reliability that is reliability of a delimiting line recognized from the image captured by the imaging device,
calculate second reliability that is reliability of a delimiting line on the map,
set the time constant greater in a case where the first reliability is less than a first reference value as compared with a case where the first reliability is equal to or more than the first reference value, and
set the time constant smaller in a case where the second reliability is less than a second reference value as compared with a case where the second reliability is equal to or more than the second reference value.

4. The vehicle control system according to claim 2, wherein the own vehicle position estimating unit is configured to set the time constant greater in a case where the vehicle is stopped as compared with a case where the vehicle is traveling.

5. The vehicle control system according to claim 2, wherein the own vehicle position estimating unit is configured to
execute a correcting process for correcting the position of the vehicle on the map, and
set the time constant smaller in a case where the own vehicle position estimating unit corrects the position of the vehicle in a travel direction thereof in the correcting process as compared with a case where the own vehicle position estimating unit does not correct the position of the vehicle in the travel direction thereof in the correcting process.

6. The vehicle control system according to claim 2, wherein the own vehicle position estimating unit is configured to decrease the time constant as a radius of curvature of the travel route becomes smaller.

7. The vehicle control system according to claim 1, wherein the own vehicle position estimating unit is configured to
stop estimating the position of the vehicle on the map in a case where both the first own vehicle position and the second own vehicle position cannot be calculated, and
estimate the position of the vehicle on the map based on only one of the first own vehicle position and the second own vehicle position in a case where the only one of the first own vehicle position and the second own vehicle position can be calculated.

8. An own vehicle position estimating method for estimating a position of a vehicle on a map, the own vehicle position estimating method comprising:
calculating a first own vehicle position based on a movement amount of the vehicle calculated by using dead reckoning;
calculating a second own vehicle position by comparing a captured image with the map; and
estimating the position of the vehicle on the map based on the first own vehicle position and the second own vehicle position.
